(19) United States
(12) Patent Application Publication
(10) Pub. No.: US 2006/0162341 A1
(43) Pub. Date: Jul. 27, 2006

(54) Comestible preparation apparatus

(76) Inventor: Stefano Milazzo, Musselburgh (GB)

Correspondence Address: YOUNG & BASILE, P.C., 3001 WEST BIG BEAVER ROAD, SUITE 624, TROY, MI, 48084, US

(21) Appl. No.: 11/390,670

(22) Filed: Mar. 28, 2006

(30) Foreign Application Priority Data
Sep. 30, 2003 (WO) PCT/GB03/04227

(51) Int. Cl. F25B 21/02; F25B 27/00; F25D 11/00; F17C 13/00

(52) U.S. Cl. 62/3.3; 62/3.6; 62/457.9; 62/238.6; 62/440

(57) ABSTRACT

The present invention provides a perishable baby comestible preparation apparatus 1 comprising a refrigerator 2 having a cold storage cabinet 4 for storing at least one baby comestible container 6, and a heating station 15 for heating a said comestible container 6. The heating station 15 comprises a housing for receiving therein a comestible container 6 for heating thereof, and the refrigerator 2 has a heat dump portion 8 thermally coupled 9 to the heating station 15.

### RELATED APPLICATION

This application claims priority to PCT Application No. PCT/GB2003/004227 filed on Sep. 30, 2003.

### FIELD OF THE INVENTION

The present invention relates to apparatus for preparing comestibles suitable for consumption by babies. BACKGROUND OF THE INVENTION

Young babies are frequently fed from a bottle rather than from a mother's breast. Feeding in this way requires suitable preparation of the baby's feed which involves in the first place storage in a refrigerator, and then warming of the feed before presenting it to the infant. It is particularly important to ensure a young baby is fed fresh, uninfected, feed due to the immaturity of their immune system. An adult may be able to tolerate consumption of a degree of microbial contamination in a comestible, however, this could cause serious health problems in a young baby. With the increased prevalence and risk of microbial infection in foodstuffs it is imperative that a baby's feed, with its potential to deteriorate or cause illness if not properly stored, should remain under cold storage conditions until immediately before warming and consumption.

This is generally achieved by keeping perishable baby comestibles in a conventional household refrigerator which is typically located in a kitchen or utility room. Frequently the mother or other child caregiver may be in a baby's bedroom or playroom which is quite remote from the household refrigerator so that when a feed is needed the caregiver must either leave the child alone or take the child to the kitchen while preparing the food. Neither scenario is desirable as harm may befall the unattended child and a kitchen is potentially one of the most dangerous rooms in the house, with all manner of dangerous appliances, and does not generally lend itself to providing safe and convivial accommodation for a baby.

The kitchen is, also, the usual place where a baby's feed is warmed. Frequently this is done by means of a bain-marie system—warming the feed in a water bath. While it is generally less likely that the feed will be substantially over-heated using this method, it is nevertheless relatively time consuming and inconvenient. The water must be pre-heated to an appropriate temperature, then the feed must be left for a sufficient period to warm, while the caregiver checks the feed at intervals to determine if it has reached an appropriate temperature. The hot water is potentially highly dangerous if accidentally spilled over a young child or the caregiver.

It is well known that a baby frequently desires or demands physical contact, cuddling or embracing when hungry and awaiting food. This often means a caregiver has to carry the child while simultaneously trying to manipulate hot water and preparing the feed. Many babies become distressed while waiting for the feed to warm which is undesirable for the baby, caregiver and other family members.

While this preparation procedure is troublesome when preparing feeds during the daytime it is particularly inconvenient during the nighttime. When a caregiver's sleep is disturbed by a crying baby (s)he has to venture out to the kitchen and go through this lengthy feed preparation procedure, often disturbing others in the house who are trying to sleep. Attempts to overcome the problems associated with exposed hot water used to warm a baby's feed have resulted in the use of electric bottle warmers. However, these are generally slow to heat, especially when a feed needs to be heated from a refrigerator storage temperature, and do not address the problems of having to access remote cold storage.

It is an object of the present invention to avoid or minimize one or more of the aforementioned disadvantages.

### SUMMARY OF THE INVENTION

In one aspect, the present invention provides a perishable baby comestible preparation apparatus comprising refrigerator having a cold storage cabinet for storing at least one baby comestible container in use of the apparatus, and a heating station for heating a said comestible container, and comprising a housing for receiving therein a said comestible container for heating thereof, said refrigerator having a heat dump portion thermally coupled to said heating station.

In a preferred aspect, the present invention provides a perishable baby comestible preparation apparatus comprising an absorption refrigerator having a cold storage cabinet for holding at least one baby comestible container in use of the apparatus, and a condenser portion, said condenser portion being provided with a by-pass portion for diverting at least part of the refrigerant flow from said condenser portion, to a heating station; said heating station comprising a housing for receiving therein a said comestible container in use of the apparatus, said housing having an inner wall surface for contacting a substantial portion of the outer wall of a said comestible container in said housing in use of the apparatus; said inner wall surface of said housing being thermally coupled to said by-pass portion, said by-pass portion having a valve for controlling diversion of refrigerant flow into said by-pass portion, thereby to control transfer of heat to said heating station.

In use of the apparatus a perishable baby comestible in a container is kept fresh by storing it in the cold storage cabinet of the absorption refrigerator. When a warm feed for a baby is required, the comestible container is simply removed from the cold storage cabinet and placed in the heating station which is heated by a hot refrigerant flow from the absorption refrigerator, which has been diverted from the normal condenser flow path through the by-pass portion of the condenser portion of the apparatus transferring heat energy via the inner wall of the heating station, to the comestible container warming the comestible.

Thus the apparatus of the present invention provides a particularly safe, convenient and rapid way of preparing a warm baby feed. By utilizing heat energy from the refrigerator which would otherwise be wasted, the apparatus is moreover highly efficient and can be used anywhere, where there is an electricity supply, rather than the usual restriction to a kitchen. The use of a relatively quiet-running absorption refrigerator also has the advantage of minimizing any possible disturbance to a baby in its bedroom.

Due to the relatively high temperature of the refrigerant flow, which may typically be of the order of 130° C., it is moreover possible to obtain quite rapid heating of the comestible.

It is generally preferred for said inner wall surface of said housing to be provided with a heat reservoir which can take up and store a relatively large amount of heat energy from the bypass circuit, which can then continue to be released for an extended period of time after the by-pass circuit has been closed off, so as to keep the comestible containers warm after it has been heated up, in the event that for some reason the comestible is not to be used immediately. The use of such a heat reservoir can also help to make the heating up of the comestible more progressive. Conveniently the heat reservoir is in the form of a liner comprising or containing a heat retaining material, preferably a non-toxic material. Various suitable materials are well known in the art for a variety of purposes such as for use in therapeutic heat treatment packs, “hot water” bottles, etc. Particular materials which may be mentioned include glycol, and sand. Advantageously there is used a liner which is more or less readily conformable to the shape of a baby's bottle or other comestible container when inserted in the heating station. Conveniently there is used a resiliently compressible material such as a silicone foam or a generally fluid material such as a heat retaining gel contained in a suitably shaped bag.

It is particularly advantageous to have such a material held in at least one bag defining the inner wall of said housing, which allows the material to be readily deformed to fit closely around the comestible container. In this way comestible containers of generally similar, though not identical, shapes and dimensions may be received in the housing while still having a substantial portion of their outer wall contacting said deformable inner walls of said housing. Preferably said housing is formed and arranged to receive a conventional, generally cylindrical, baby's feed bottle, though it will be understood that variations on this shape are also included.

The inner wall of the housing could nevertheless also be of a non-deformable material, e.g., metal, with good thermal transfer properties which is formed and arranged to receive therein a baby comestible container, with a relatively close fit.

It is preferable for said by-pass portion of said condenser portion of said refrigerator to be formed and arranged to maximize transfer of heat to said inner wall of said housing most preferably, to at least a substantial part of said inner wall. The by-pass portion conveniently has a generally helical portion extending around and along the housing inner wall, but it will be appreciated that other configurations, suitable for providing generally even heat transfer, may also be adopted

It will be appreciated that the electricity supply to the absorption refrigerator can be activated by a standard switched wall socket-plug system. It is though generally preferable to have an additional manual control switch for the apparatus. Preferably at least one further switch is provided so that the absorption refrigerator and the heating station may be controlled independently.

It will be appreciated by those skilled in the art that various types of valve may be used for controlling diversion of refrigerant flow into said by-pass portion. The valve may be mechanical and operated manually or in the form of a solenoid valve in an electrical switching circuit and/or a thermostatic valve.

Preferably said heating station is provided with an automatic “cut-off” switch. This prevents over-heating of an unattended or forgotten comestible container in use of the apparatus. Such an automatic switch could be a timer switch and/or a temperature control switch. A timer switch can be manually set each time the apparatus is used. Alternatively the timer can be pre-set to inactivate the heating station after a sufficient time has elapsed which would warm a typical baby comestible dosage to an acceptable temperature from a typical starting temperature. The latter would generally be based on milk taken from the cold storage cabinet. Alternatively, the setting may be pre-programmed on the basis of the volume of comestible to be heated with settings for, for example, 100 ml, 200 ml, etc. It will be appreciated, however, that babies will tolerate food at a range of temperatures and such a pre-set timer switch may be set to encompass a range of starting temperatures and volumes which results in the comestible being warmed to a temperature in the range from 30 to 40° C., advantageously from 35 to 40° C. Where a temperature sensitive control switch is provided it is preferably formed and arranged for more or less closely monitoring the temperature of the comestible container and shutting off said refrigerant flow through said by-pass portion of the condenser portion when the comestible container is heated adequately.

It is preferable for said apparatus to have a signal device to notify a user of the heating station when the comestible has been heated. It is also desirable to have a signal to indicate when said heating station is in use. Such signals may be of various forms such as illuminated light as LED indicators or other visual signals, audio signals or other signals perceptive to a user's senses.

It will be appreciated that during use the heating station will become relatively hot. Preferably the housing of said heating station is provided with insulated outer walls to prevent transfer of heat to the exterior of said apparatus. This is particularly important when the apparatus is used in the vicinity of young children. More preferably said apparatus is provided with a thermally insulated safety cover to prevent access to the heated components of the heating station and comestible being heated when the heating station is in use. Still more preferably said safety cover has a child proof closing mechanism. It may also be desirable to provide an additional safety override switch which is activated by the safety cover when this is in position to automatically prevent the valve controlling diversion of the refrigerant flow to the by-pass portion from opening when the safety cover is not securely closed.

### BRIEF DESCRIPTION OF THE DRAWINGS

Further preferred features and advantages of the invention will appear from the following examples and detailed description provided for the purposes of illustration and illustrated with reference to the accompanying drawings in which:

FIG. 1 is a rear perspective view of a perishable baby comestible preparation apparatus of the present invention;

FIG. 2 is a detail perspective view of part of the heating station of the apparatus of FIG. 1 showing a baby's bottle held in the heat reservoir liner of the heating station of the apparatus of FIG. 1;

FIG. 3 is a schematic perspective view of another embodiment of the invention; and

FIG. 4 is an exploded perspective view of the principal parts of a further embodiment of the invention.

### DETAILED DESCRIPTION OF ILLUSTRATIVE EMBODIMENTS

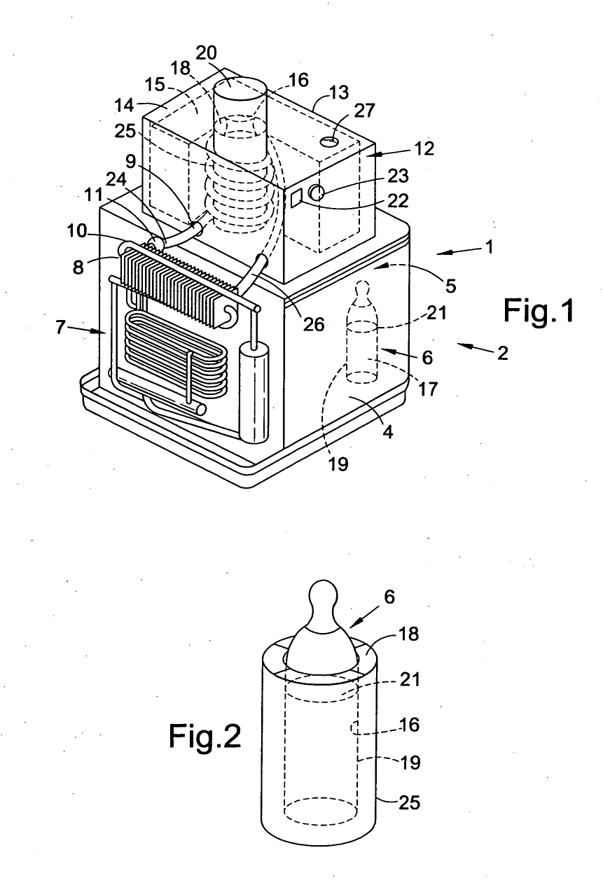

FIG. 1 shows a perishable baby comestible preparation apparatus 1 with a generally box shaped absorption refrigerator 2 mounted on a base platform 3. A cold storage cabinet 4 inside the refrigerator 2 is accessible from a door (not shown) at the front 5 thereof. The cold storage cabinet 4,can hold baby comestible containers such as a baby bottle 6, though other containers such as milk cartons (not shown) may also be stored.

The exposed parts of the absorption refrigerator plumbing 7 at the back of the refrigerator 2, include a condenser 8 which has a by-pass portion 9 flows. Diversion of hot refrigerant flow 10 in the condenser 8 to by-pass portion 9 is controlled by a timer switch controlled valve 11.

The apparatus 1 has a generally box shape heating station 12 positioned on top of the absorption refrigerator 2. The housing 13 of the heating station has thermally insulated walls 14 to limit transfer of heat from the interior of the heating station 15 to its outer surface 14. The inner walls 16 of the heating station are formed to receive the bottle 6 when the contents 17 of the bottle 6 are to be heated. The inner walls 16 are defined by bags 18 containing glycol. The glycol filled bags 18 are reversibly deformable so that when the bottle 6 is inserted between them they conform to the outer walls of the bottle 19, such that the inner walls of the housing 16 contact substantially all of the outer wall of the bottle 19 (as shown in FIG. 2), particularly up to the level where the bottle 6 is filled with comestible to be heated 21.

When the bottle 6 is placed inside the glycol bag liner 18, a child proof thermally insulated safety cover 20 is placed over the bottle 6 and glycol bag liner 18 to prevent access to the bottle 6 and hot interior portion of the heating station 15 during heating.

The heating station 15 is activated by manually switching an “on/off” switch 22. The apparatus may be provided with a timer control 23 to select a suitable heating time by duration or quantity of comestible to be heated on the basis of pre-programmed timer settings.

When the “on/off” switch 22 is switched on, valve 11 is opened and hot refrigerant flow 10 from the condenser 8 of the absorption refrigerator 2 flows into by-pass portion 9 at by-pass portion inlet 24. By-pass portion 9 coils around the outer surface 25 of the glycol bags 18, transferring heat from the refrigerant flow 10 to the glycol bags 18, which in turn transfer heat to the bottle 6 and comestible 17 therein. The by-pass portion 9 flows on past the glycol bags 18 and re-enters the condenser 8 at by-pass portion outlet 26, downstream of the by-pass portion inlet 24.

Refrigerant fluid 10 continues to flow through by-pass portion 9, heating the bottle 6, until timer switch controlled valve 11 closes. A light indicator 27 signals the bottle 6 has been heated. The safety cover 20 can be removed and the bottle 6 removed, suitably warmed and ready to feed to a baby. If it is not convenient to feed the baby immediately after the bottle 6 has been heated, the glycol bags 18 act as a heat reservoir and keep the comestible sufficiently warn and limit heat loss from the bottle 6 until it is convenient to feed the baby.

It will be appreciated that from the time a caregiver realizes a feed is required to the time of the feed being warmed minimal effort and attention is required. The caregiver need only take the bottle, filled with comestible, out of the cold storage cabinet, place it in the heating station, place the safety cover in position and switch on the heating station. A bottle of 200 ml of milk typically heating within ten minutes.

Conveniently the apparatus 1 also includes a storage area 28 for holding items such as disposable diapers, wipes and other baby accessories and nonperishable consumables.

Those skilled in the art will appreciate that the aforementioned forms of the baby comestible preparation apparatus of the present invention merely serve as examples and various modifications may be made to the above-described embodiments without departing from the scope of the invention.

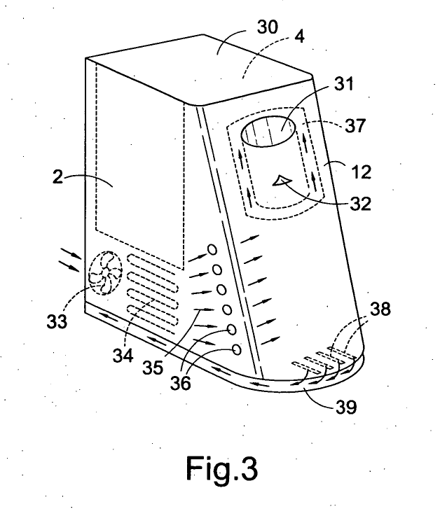

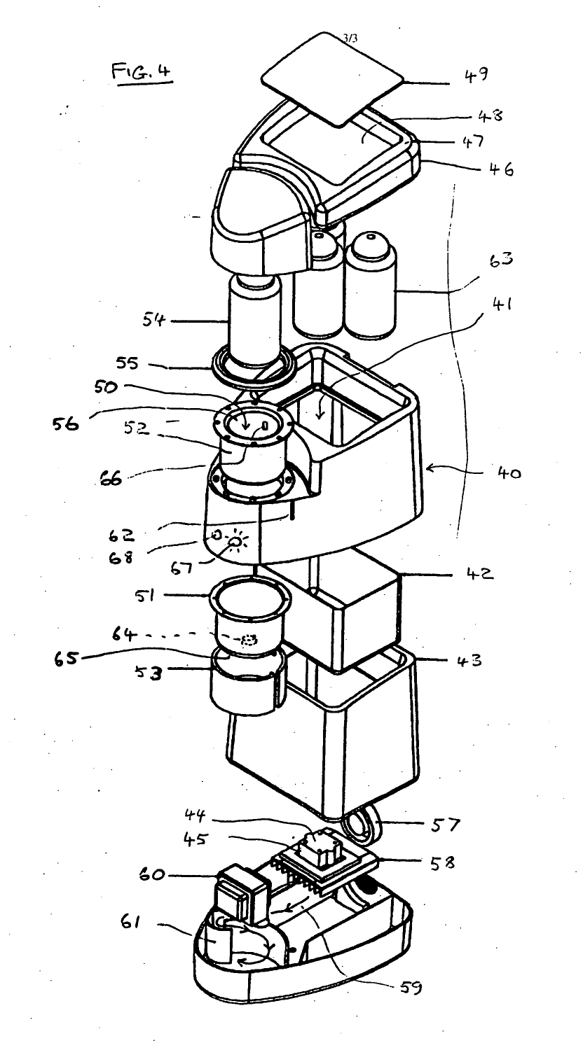

FIG. 3 shows another apparatus 29 of the invention with like parts corresponding to those in FIG. 1 being indicated by like reference numbers. The apparatus 29 has a refrigerator 2 with a cold staorage cabinet 4 accessed via a door 30. The apparatus 29 also has a heating station 12 with a bottle warmer holder 31 provided with a heat sensor 32 for accurately detecting the temperature of a bottle (not shown) placed in the holder 31. A fan 33 is mounted for blowing air across a fridge unit 34 to push heated air flows 35 through apertures 36 into thermal channels 37 around the bottle holder 31 and finally out of exhaust apertures 38 at the underside 39 of the apparatus. Possible variants of the above apparatus include the use of a hot air blower heating booster and/or thermoelectric heating or cooling.

FIG. 4 shows an exploded perspective view of the principal parts of a further embodiment of an apparatus 40 of the present invention. In this embodiment the refrigeration compartment 41 has a thermally conducting metal case 42 surrounded by thermal insulation 43 and in direct thermal contact with a cooling portion 44 of a solid state Peltier refrigeration unit 45. The refrigeration compartment 41 has a lid 46 in the upper face 47 of which is provided a shallow storage compartment 48 for sundries such as wipes etc (not shown) and which in turn has a lid 49.

The heating compartment 50 is in the form of a thermally metal conducting metal can 51 lined internally with a sleeve 52 filled with food grade monopropylene glycol gel which can hold heat for a considerable period of time, and lined externally with a jacket in the form of a flexible thin film electric heater element 53. The gel filled sleeve 52 fits closely around a baby feed bottle 54 which is to be warmed and/or kept warm in use of the apparatus 40. A bezel 55 is provided around the mouth 56 of the heating compartment 50.

A fan 57 is provided opposite a heat sink portion 58 of the solid sate refrigeration unit 45 so as to direct a flow of air 59 across the heat sink portion 58 as well as an electrical transformer 60. The airflow 59 is channeled by guide walls 61 provided underneath the heating compartment 50 so as to direct the warm airflow 59 into a vortex which rises up around the heater jacket 53, through which heat is transferred to the bottle 54 via the gel-filled sleeve 52, before exiting the apparatus 40 through vents 62. It is generally accepted that baby's milk can be safely kept warm for up to 3 hours or so. Thus the heating compartment 50 may be used to maintain the temperature of a ready-to-use feed bottle by simply making use of the heated airflow. Where additional heat is required to bring up to temperature more or less quickly a chilled feed bottle 63 from the refrigerator compartment, then the heater element jacket 53 is activated—conveniently via a push button switch 64 provided in the base 65 of the metal can 51, which is actuated by the bottle 54 being pushed down onto it. In order to prevent overheating of the baby feed bottle 63, the heater element jacket 53 is desirably provided with a thermostat control with at least one temperature sensor 66 is provided on the sleeve 52 for contacting the feed bottle 54. Operation of the heater element jacket 53 is indicated by an indicator light 67, and an override switch 68 is conveniently provided to deactivate the heating jacket 53 entirely when this is not required to be used.

What is claimed is:

1. A perishable baby comestible preparation apparatus comprising a refrigerator having a cold storage cabinet for storing at least one baby comestible container in use of the apparatus, and a heating station for heating a said comestible container, and comprising a housing for receiving therein a said comestible container for heating thereof, said refrigerator having a heat dump portion thermally coupled to said heating station.

2. An apparatus as claimed in claim 1 wherein the refrigerator is an absorption refrigerator.

3. An apparatus as claimed in claim 1 wherein the refrigerator is a thermoelectric refrigerator.

4. An apparatus as claimed in claim 1 wherein the refrigerator is a compressor refrigerator.

5. An apparatus as claimed in claim 1 wherein said heat dump portion is thermally coupled to said heating station by a heat exchange fluid flow system.

6. An apparatus as claimed in claim 5 wherein said heat exchange fluid flow system comprises a convection fluid flow system.

7. An apparatus as claimed in claim 5 wherein said heat exchange fluid flow system comprises a fan assisted fluid flow system.

8. An apparatus as claimed in claim 1 wherein said heat dump portion is thermally coupled to said heating station by at least one thermally conducting element.

9. An apparatus as claimed in claim 1 wherein said heating station is provided with a temperature sensor formed and arranged for monitoring the temperature of a said comestible container in use of the apparatus, and there is provided a heat exchange controller formed and arranged for adjusting the thermal coupling between said heat dump portion and said heating station in response to excursions of the detected temperature from a predetermined target range, so as to bring the temperature back within said range.

10. An apparatus as claimed in claim 1 wherein said heating station is provided with a temperature sensor formed and arranged for monitoring the temperature of a said comestible container in use of the apparatus, and there is provided a cooling device formed and arranged for cooling the heating station in response to excursions of the detected temperature above a predetermined limit, so as to bring the temperature back within said range.

11. A perishable baby comestible preparation apparatus comprising an absorption refrigerator having a cold storage cabinet for holding at least one baby comestible container in use of the apparatus, and a condenser portion, said condenser portion being provided with a by-pass portion for diverting at least part of the refrigerant flow from said condenser portion, to a heating station; said heating station comprising a housing for receiving therein a said comestible container in use of the apparatus, said housing having an inner wall surface for contacting a substantial portion of the outer wall of a said comestible container in said housing in use of the apparatus; said inner wall surface of said housing being thermally coupled to said by-pass portion, said by-pass portion having a valve for controlling diversion of refrigerant flow into said by-pass portion, thereby to control transfer of heat to said heating station.
